(19) United States
(12) Patent Application Publication
(10) Pub. No.: US 2011/0213810 A1
(43) Pub. Date: Sep. 1, 2011

(54) DYNAMICALLY CONFIGURABLE CHAMELEON DEVICE

(75) Inventor: Michael Patrick Chrabaszcz, Milpitas, CA (US)

(73) Assignee: Rovi Technologies Corporation, Santa Clara, CA (US)

(21) Appl. No.: 12/713,538

(22) Filed: Feb. 26, 2010

(51) Int. Cl. G06F 15/177; G06F 15/16; G06F 17/30

(52) U.S. Cl. 707/803; 709/220; 709/203; 707/E17.044; 707/E17.005

(57) ABSTRACT

A dynamically configurable apparatus and methods for dynamically configuring the apparatus are provided. A list of resources available to the apparatus may be identified and communicated to a server computer and a list of functionalities performable by the apparatus, based on the list of resources, may be received from the server computer. A user selects one or more functionalities from the list of functionalities. The server computer may provide the apparatus with additional resources based on the selected functionalities. The apparatus preferably configures itself to perform the selected functionalities by using the additional resources. Additional apparatus and methods are disclosed.

### CROSS-REFERENCE TO RELATED APPLICATIONS

The present application is related to the following patent applications each assigned to a common assignee:

U.S. patent application Ser. No. [2147.027US1, CP0020] entitled, “DYNAMICALLY CONFIGURABLE CLUSTERS OF APPARATUSES,” which is hereby incorporated by reference.

U.S. patent application Ser. No. 12/622,766, filed on Nov. 20, 2009 and entitled, “DATA DELIVERY FOR A CONTENT SYSTEM,” which is hereby incorporated by reference.

### BACKGROUND

As the market for consumer electronics (CE) expands, more and more sophisticated CE devices become available. Today's CE device manufacturers are facing demands for more advanced features which can only be satisfied with high technology solutions. The use of processing power in many CE devices facilitates providing more technically advanced features in more compact and less expensive CE devices, such as various hand-held devices.

Also, network connectivity is becoming a new trend in more CE devices. For example, new models of television sets manufactured by various vendors are equipped with Internet capabilities for content delivery without the need for a personal computer. Such Internet connectivity features may drastically improve the functionality of CE devices that utilizes this feature.

### BRIEF DESCRIPTION OF THE DRAWINGS

Some embodiments of the disclosed technology are illustrated by way of example and not limitation in the figures of the accompanying drawings in which:

FIG. 1 is a diagram illustrating an example system for dynamically configuring an apparatus, according to various embodiments of the invention;

FIG. 2 is a high-level diagram illustrating an example dynamically configurable apparatus, according to various embodiments of the invention;

FIG. 3 is a diagram illustrating an example dynamically configurable apparatus, according to various embodiments of the invention;

FIG. 4 is a block diagram illustrating example modules of a dynamically configurable apparatus, according to various embodiments of the invention;

FIG. 5 is a flow diagram illustrating an example method of dynamically configuring an apparatus, according to various embodiments of the invention;

FIG. 6 is a block diagram illustrating an example architecture of a dynamically configurable consumer electronic device, according to various embodiments of the invention; and

FIG. 7 is a diagram illustrating a diagrammatic representation of a dynamically configurable apparatus in the example form of a computer system.

### DETAILED DESCRIPTION

An example dynamically configurable apparatus and methods for dynamically configuring the apparatus is described. In the following description for the purpose of explanation, numerous examples having example-specific details are set forth to provide an understanding of example embodiments. It will be evident, however, to one of ordinary skill in the art that the present examples may be practiced without these example-specific details, and/or with different combinations of the details than are given here.

Some example embodiments described herein may include a method for dynamically configuring an apparatus. The method may include identifying a list of resources available to the configurable apparatus, also called configurable chameleon device, and communicating the list of identified resources to a server computer. A list of functionalities performable by the apparatus based on the list of resources may be received from the server computer. A user may select one or more functionalities from the list of functionalities. The server computer provides the apparatus with additional resources based on the selected functionalities. The apparatus may redefine/configure itself to perform the selected functionalities using the additional resources.

Example methods may include dynamically identifying the list of resources initially such as, for example, after the apparatus is turned on for the first time, and/or upon detecting a change in the resources available to the apparatus such as, for example, when an external resource such as a universal serial bus (USB) is coupled to the apparatus. The resources initially available to the apparatus may include sufficient capabilities to perform an initial bringing up of an operating system and providing a network connection to a server computer. In implementations, the network includes the Internet, or another network. Generally, the apparatus at this point is blank in terms of any functionality or feature that is utilized by a user. However, the apparatus is able to redefine itself by configuring its resources to perform various functionalities as discussed in more detail below.

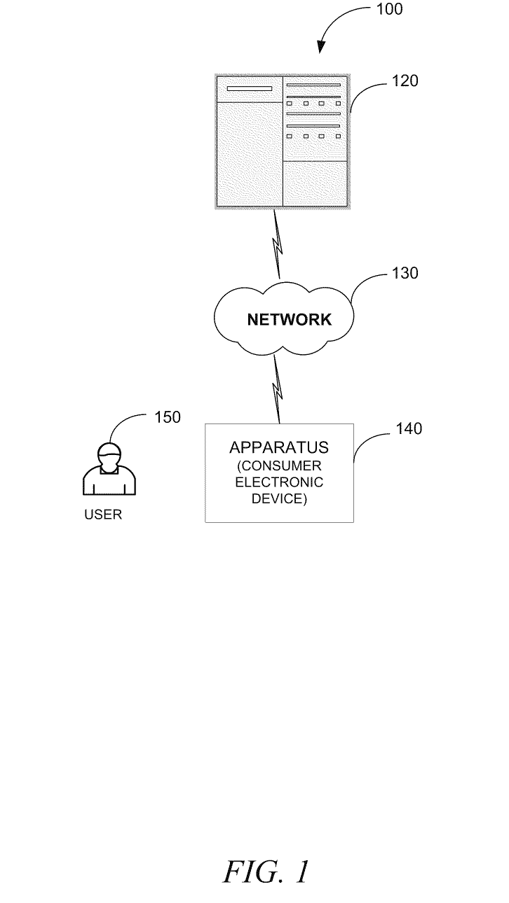

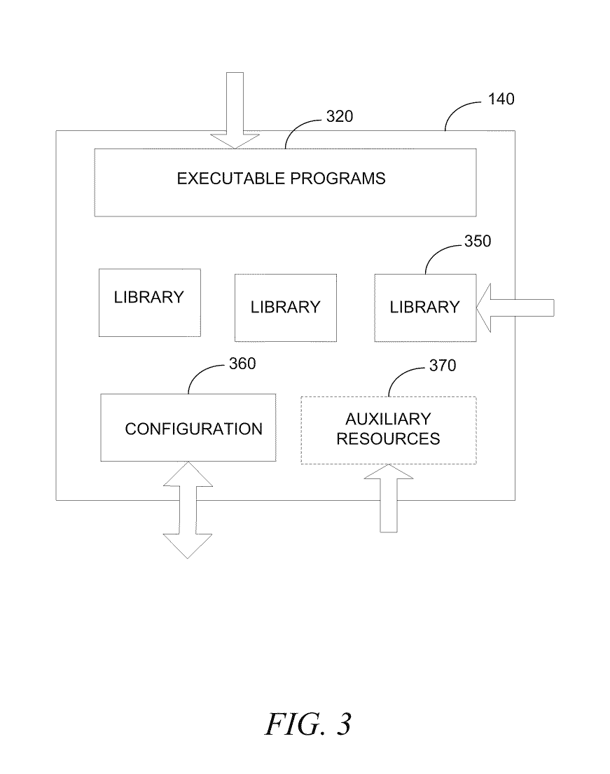

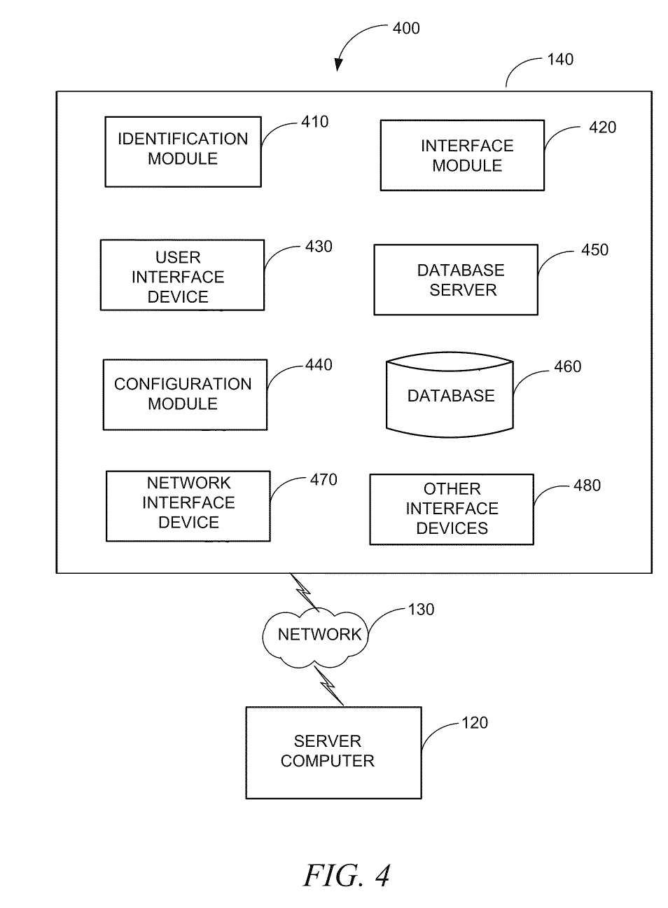

FIG. 1 is a diagram illustrating an example system 100 for dynamically configuring an apparatus 140, according to various embodiments of the invention. The system 100 may include the apparatus 140, a network 130 and a server computer (hereinafter, also called “server”) 120. The apparatus 140 may initially identify a list of resources that may be available to the apparatus 140 as shown, for example, in FIGS. 3 and 4. The apparatus 140 may identify the list of resources dynamically such as, for example, upon detection of a change in the resources. A change in resources may occur, for instance, when the apparatus 140 detects that a new device such as a USB type device is coupled to the apparatus 140.

Following the identification of resources, the apparatus 140 may communicate with the server 120. Generally, the server 120 is maintained and/or operated by a service provider such as, for example, a host service provider. After communicating with the server 120, the apparatus 140 may identify itself, for instance, via a registration number, etc., to the server 120 and after some authentication processes, provide the server 120 with a list of identified resources that are available to the apparatus 140. The resources may include hardware and/or software resources.

The server 120 may analyze the list of resources received from the apparatus 120 and, based on the potential capabilities of the resources, provide a list of functionalities to the apparatus 140. In an example embodiment, the server 120 is able to detect the resources available to the apparatus 140 upon coupling of the apparatus 140 to the server 120. The list of functionalities provided by the server 120 may be presented to a user 150 as configuration/feature options. The list of functionalities may include, for example, functionalities associated with consumer electronic devices such as a television, a digital versatile disk (DVD) player and/or recorder, a compact disk (CD) player and/or recorder, a personal video recorder (PVR) or functionalities of more sophisticated scientific and/or research instruments such as an oscilloscope or a pulse height analyzer (PHA), and so forth.

The user 150 may select one or more desired configuration and/or feature options. For example, the user 150 may want to use the apparatus 140 as a personal video recorder (PVR). In this case, after receiving the additional resources, the apparatus 140 may redefine itself by configuring its resources to perform as a PVR. The apparatus 140 may perform the functionality of a PVR and at the same time offer features such as, for example, a number and type of controls or displays, etc., that are selected by the user 150.

Currently available consumer electronic devices may at most be able to download update files from a server via the Internet. However, the capabilities discussed above with respect to the apparatus 140 being able to redefine or configure itself to perform one or more desired functionalities and/or features selected by the user 150 are not present in existing devices or instruments. For example, as the hardware and software configuration of the apparatus 140 changes such as, for example, by adding new hardware or downloading new features, the list of available features offered to the user 150 are dynamically adjusted. More details regarding various resources available to the apparatus 140 and additional resources provided by the server 120 are discussed below.

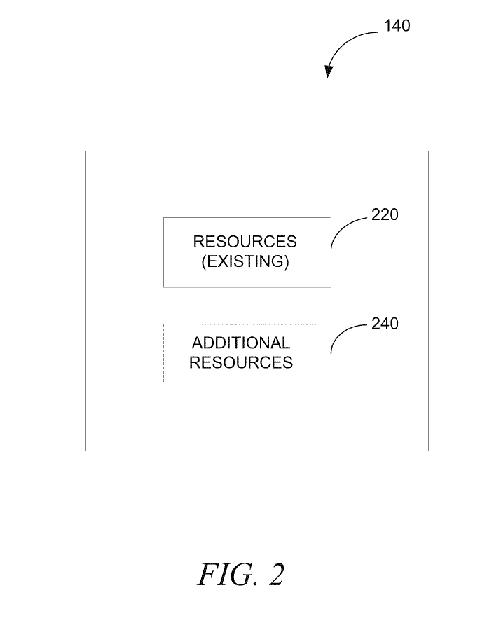

FIG. 2 is a high-level diagram illustrating an example dynamically configurable apparatus 140, according to various embodiments of the invention. The apparatus 140 may initially include resources 220. The resources 220 may, for example, include some processing power such as via one or more processors, or some storage capacity, for example, in the form of volatile memory, such as random access memory (RAM), non-volatile memory, such as read only memory (ROM), flash memory, and the like. The resources 220 may also include one or more interfaces such as audio and/or video inputs, outputs, USB interfaces, network and/or Ethernet interfaces, public switched telephone network (PSTN) jacks, high definition multimedia interfaces (HDMI), antennas, etc.

After reporting the existing resources 220 to the server 120, the apparatus 140 may receive additional resources 240. The additional resources 240 may include software applications and/or one or more databases. The databases may contain libraries, configuration files, images, fonts, and so forth. The software may include various applications and executable programs that are executable by the resources 220. In example embodiments, the applications and executable programs may also employ other components of the additional resources 240, including libraries and databases.

FIG. 3 is a diagram illustrating an example dynamically configurable apparatus 140, according to various embodiments of the invention. In the example embodiment show in FIG. 3, only the dynamic components of the resources 220 available to the apparatus 140 are shown. For example, executable programs 320 may be modified by the server 120, or library 350 may be part of the additional resources provided by the server 120 to equip the apparatus 140 with certain functionalities. The configuration 360 may include configuration files that are provided or updated by the server 120. The configuration 360 may also save the current configuration of the apparatus 140 in certain configuration files.

The auxiliary resources 370 are coupled to the apparatus 140 to provide additional functionalities and/or features to the apparatus 140. In some cases, an auxiliary resource 370 is coupled and internal within the apparatus 140. For example, the auxiliary resources 370 may include certain internal and/or external interface cards coupled to the apparatus 140. Technical specifications of the auxiliary resources 370 may be reported to the server 120. The server 120, based on the added capabilities of the auxiliary resources 370, provide the apparatus 140 with executable programs, such as drivers and/or libraries such as dynamic link libraries (DLL) to enable the apparatus 140 to perform new functionalities.

FIG. 4 is a block diagram illustrating example modules 400 of a dynamically configurable apparatus 140, according to various embodiments of the invention. The apparatus 140 may include an identification module 410, an interface module 420, a user interface device 430, a configuration module 440, a database server 450, a database 460, a network interface device 470 and other interface devices 480. The apparatus 140 may be coupled to the server 120 via the network 130.

The identification module 410 preferably identifies the list of resources 220 initially available to the apparatus 140. However, the identification module 410 may act dynamically; for example, when an external device such as an auxiliary resource 370, for example, is coupled to the apparatus 140, the identification module 410 may identify the external device and update the list of resources 220 of FIG. 2.

The identification module 410 is further preferably able to detect technical specifications of the resources 220 of FIG. 2 and provide them to the configuration module 440, the database server 450 and/or the network interface device 470. The network interface device 470 may communicate the list of the resources 220 to the server 120 via the network 130. The network interface device 470 may also communicate a request for a list of functionalities to the server 120. The server 120 may analyze the list of resources 220, and based on the capabilities and capacitances of the resources 220, prepare a list of functionalities that the apparatus 140 is able to perform. The list of functionalities is received by the network interface device 470 and passed to the database server 450 to be stored in database 460.

The interface module 420 may obtain the list of functionalities from the database 460 and provide an interface to the user interface device 430. The interface may include functionality and/or feature options for presentation to the user 150. The user interface device 430 may display the user interface to the user 150. The user 150 may select one or more of the displayed functionality and/or feature options. The selected functionality and/or feature options are communicated by the network interface device 470 to the server 120. The server 120 may provide the apparatus 140 with additional resources 240 of FIG. 2. Using the additional resources 240 and the existing resources 220, the apparatus 140 advantageously performs the functionalities and features desired by the user 150.

The other interface devices 480 may include audio and/or video inputs, outputs, USB interfaces, network interfaces, Ethernet interfaces, public switched telephone network (PSTN) jacks, high definition multimedia interface (HDMI), antennas, and so forth. Once identified to the server 120, each of the other interface devices 480, may become part of a solution to provide certain functionality to the apparatus 140.

Once the additional resources 240 of FIG. 2 are received by the apparatus 140, the configuration module 440 may configure the apparatus 140 to perform functionalities selected by the user 150 of FIG. 1. The configuration module 440 also preferably stores the current configuration of the apparatus 140 within the database 460. The current configuration may be a temporary configuration that the user 150 uses for a limited time, for example, over a weekend. After that time, the user may select or switch to a different functionality, as long as that functionality is provided by the server 120.

Many consumer electronic devices use operations that may allow hackers to break into the device, identify executables and libraries, and reverse engineer the device. In an example embodiment, the present inventive subject matter may protect the apparatus 140 from such hacking activities by using the database 460 to store configurations, executables and libraries. In another example embodiment, the database 460 may further protect the apparatus 140 by encrypting stored features. Some embodiments employ a structured query language (SQL) database.

Once the apparatus 140 is configured, the user 150 may add new hardware that implements, for example, one or more of the auxiliary resources 370 of FIG. 3. The user 150 may further upgrade functionalities that the apparatus 140 is capable of performing. For instance, the user 150 may download new functionalities and/or features from the server 120. In a particular case, the user 150 couples a USB device to the apparatus 140 that includes, for example, a digital television. Then, the user 150 advantageously configures the television as a PVR for use of the PVR functions by the user. The alternative configuration may occur at a remote location and/or for a limited time. For instance, the alternative configuration for the television and PVR combination device may be during a weekend so that the user 150 is enabled to rent software while visiting a beach vacation house or another temporary location. The configuration module 440 may automatically disable a functionality related to the resource associated with the external device, e.g., the USB device, after the external device is disconnected and/or removed from the apparatus 140.

In an example embodiment, the user 150 may desire to have a certain added functionality within the apparatus 140, but is not sure how the apparatus 140 is able to perform that functionality. The user 150 communicates the desired functionality to the user interface device 430. The user interface device may pass the desired functionality to the network interface device 470, which may in turn communicate the desired functionality to the server 120.

The server 120 may analyze the situation and provide the network interface device 470 with a list of one or more external devices that is coupled to the apparatus 140 to perform the desired functionality. The user interface device 430 may receive the list of one or more external devices and communicate the list to the user 150. Once the one or more external devices are coupled to the apparatus 140, the configuration module 440 configures the apparatus 140 to perform the desired functionality.

In some embodiments, the server 120 communicates warnings to the user 150 with respect to possible performance issues when the apparatus 140 lacks sufficient capabilities or marginally meets the requirements to support a requested functionality. For example, the user 150 may request PVR functionality where the apparatus 140 has a flash memory and/or removable memory stick as the only available memory. The server 120 may warn the user 150 of potential poor user experience, based on historical data and/or customer feedback stored in a database.

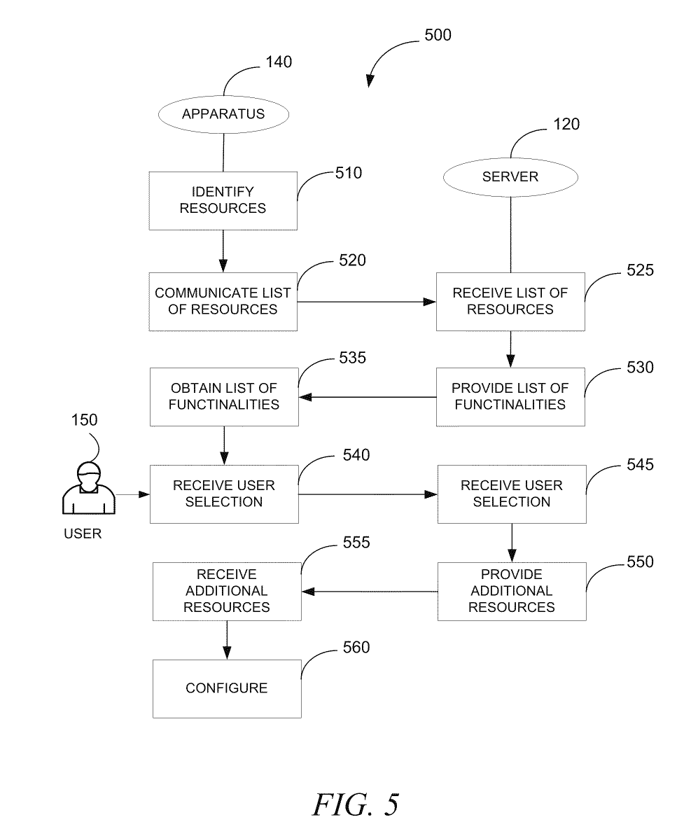

FIG. 5 is a flow diagram illustrating an example method 500 of dynamically configuring an apparatus 140, according to various embodiments of the invention. As shown in FIG. 5, the method 500 begins at operation 510, where the identification module 410 of FIG. 4 dynamically identifies a list of resources 220 of FIG. 2 available to the apparatus 140 of FIG. 1.

At operation 520, in response to the identification, the network interface device 470 may communicate the list of resources 220 to the server 120 over the network 130 of FIG. 1. At operation 525, the server 120 receives the list of resources 220 from the apparatus 140. The server 120 may analyze the list of resources 220 available to the apparatus 120 to prepare a list of functionalities based on the list of resources 220. At operation 530, the server 120 may provide the apparatus 140 with the list of functionalities.

In some embodiments, the server 120 generates a database to store the list of identified resources 220, the list of functionalities and a current configuration of the apparatus 140. The server 120 may dynamically update the database. The server 120 may provide the apparatus 140 with promotional materials to present to the user 150. The promotional materials may be in the form of advertisements that promote various functionalities performable by the apparatus 140 to the user 150.

At operation 535, the network interface device 470 may receive the list of functionalities form the server 120 over the network 130. The network interface device 470 may pass the list of functionalities to the database server 450 of FIG. 4 to store in the database 460 of FIG. 4. The user interface module 420 of FIG. 4 may obtain the list of functionalities from the database 460 and prepare an interface showing the list of functionalities in a presentable format.

At operation 540, the user interface device 430 of FIG. 4 may display the interface to the user 150 and receive a selection from the list of functionalities from the user 150. The network interface device 470 may communicate the selection to the server 120 over the network 130. At operation 545, the server 120 may receive the selection from the network interface device 470. The server 120 may, at operation 550, provide additional resources 240 of FIG. 2 to the apparatus 140. The additional resources 240 may be provided based on the selected functionalities by the user 150.

At operation 555, the network interface device 470 may receive additional resources 240 and pass them to the database server 450 for storage in the database 460. The configuration module 440 of FIG. 4 may obtain a list of the additional resources from the database 460. At operation 560, the configuration module 440 may configure the apparatus 140 to perform the selected functionalities by using the resources 220 available to the apparatus 140 and the additional resources 240 provided by the server 120. The configuration module 440 may also save the current configuration of the apparatus 140 within the database 460.

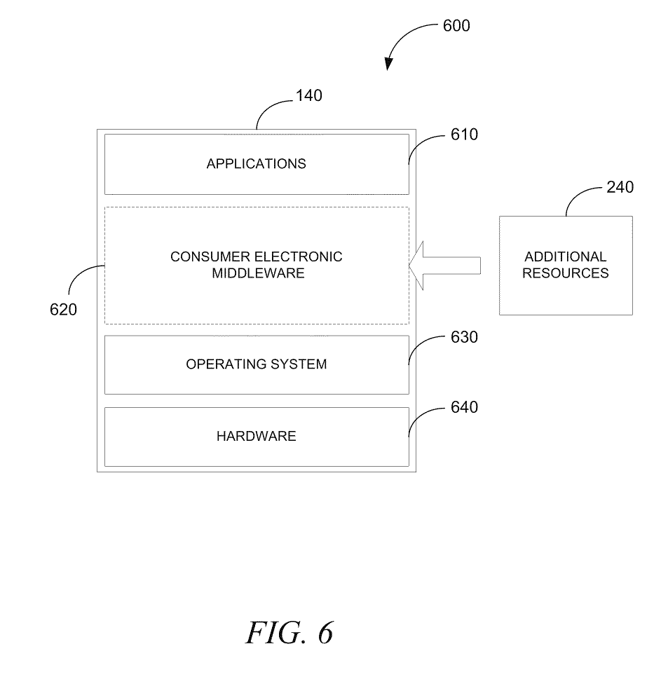

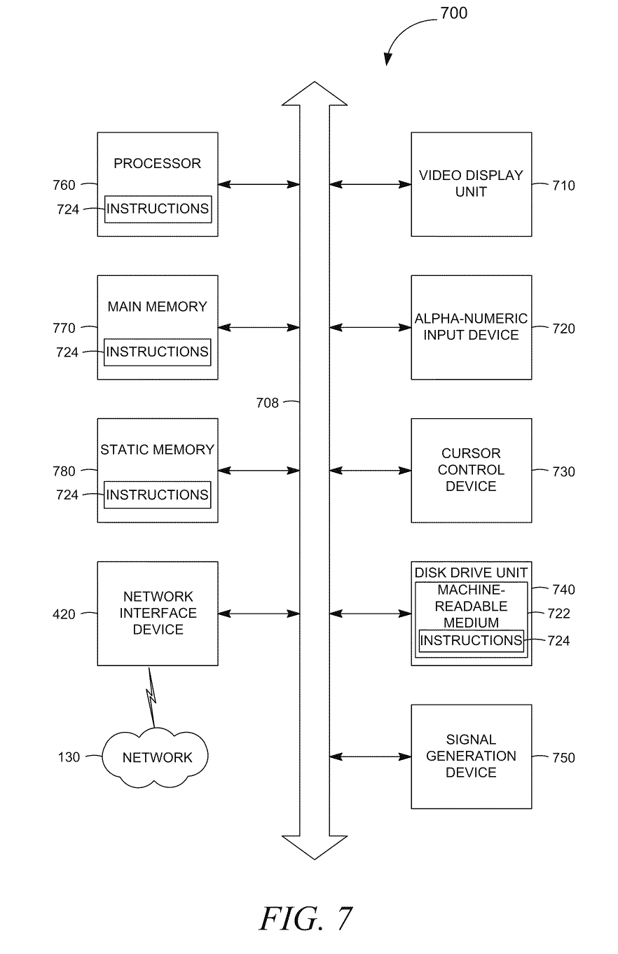

FIG. 6 is a block diagram illustrating an example architecture 600 of a dynamically configurable consumer electronic device, according to various embodiments of the invention. The consumer electronic device may be an embodiment of the apparatus 140 as shown in FIG. 6. In the architecture 600, the hardware block 640 may include various hardware, for example, memory, processors, input and/or output devices, interface devices, amplifiers, tuners, etc. In example embodiments, the hardware block 640 may include entire components and/or portions of the components of the apparatus 700, as shown in FIG. 7. FIG. 7 is further discussed below. The hardware block 640 may be modified by a user via coupling external devices, such as various electronic boards, USB devices, network interface devices, and the like.

The operating system 630 may include Linux or various other operating systems. The apparatus 140 may be able to bring up this operating system upon powering up at its initial state to enable the apparatus 140 to communicate with the server 120 and the network 130 of FIG. 1. In example embodiments, the consumer electronic middleware 620 may be modified to include the additional resources 240. The additional resources 240 may include one or more software and/or databases. The databases may contain libraries, configuration files, images and fonts, and so forth. The software may include various applications and executable programs that are executable by the hardware block 640. In example embodiments, the applications and executable programs included in the additional resources 240 also employ other components of the additional resources 240, including libraries and databases. The applications and executable programs included in the additional resources 240 may also use contents of applications block 610. The applications block 610 may include software which initially existed in the original configuration of the apparatus 140.

FIG. 7 is a diagram illustrating a diagrammatic representation of a dynamically configurable apparatus 700 in the example form of a computer system, within which a set of instructions for causing the apparatus 700 to perform one or more of the methodologies discussed herein may be executed. In alternative embodiments, the apparatus 700 operate as a standalone device or are coupled and/or networked to other apparatus. In a networked deployment, the apparatus 700 may operate in the capacity of a server or a client apparatus in a server-client network environment, or as a peer apparatus in a peer-to-peer and/or distributed network environment.

The apparatus 700 may be a server computer, a client computer, a personal computer (PC), a tablet PC, a set-top box (STB), a personal digital assistant (PDA), a cellular telephone, an Internet or Web appliance, a network router, switch or bridge, or any apparatus capable of executing a set of instructions, sequential or otherwise, that specify actions to be taken by that apparatus. Further, while only a single apparatus is illustrated, the term “apparatus” shall also be taken to include any collection of apparatuses that individually or jointly execute a set, or multiple sets, of instructions to perform any one or more of the methodologies discussed herein.

The example apparatus 700 may include a processor 760 such as, for example, a central processing unit (CPU), a graphics processing unit (GPU), or both, a main memory 770 and a static memory 780, all of which communicate with each other via a bus 708. The apparatus 700 may further include a video display unit 710 such as, for example, a liquid crystal display (LCD) or cathode ray tube (CRT) display. The apparatus 700 also may include an alphanumeric input device 720 such as, for example, a keyboard, a cursor control device 730, e.g., a mouse, a disk drive unit 740, a signal generation device 750, e.g., a speaker, and a network interface device 420.

The disk drive unit 740 may include a machine-readable medium 722 on which is stored one or more sets of instructions 724 such as, for example, software embodying any one or more of the methodologies or functions described herein. The instructions 724 may also reside, completely or at least partially, within the main memory 770 and/or within the processor 760 during execution thereof by the apparatus 700. Preferably, the main memory 770 and the processor 760 also comprise machine-readable media. The instructions 724 may further be transmitted or received over a network 130 via the network interface device 420.

While the machine-readable medium 722 is shown in an example embodiment to be a single medium, the term “machine-readable medium” should be taken to include a single medium or multiple media such as, for example, media found in a centralized or distributed database, and/or associated caches and servers that store the one or more sets of instructions. The term “machine-readable medium” shall also be taken to include any medium that is capable of storing, encoding, and/or carrying a set of instructions for execution by the apparatus and that cause the apparatus to perform any one or more of the methodologies of the present technology. The term “machine-readable medium” shall accordingly be taken to include, but not be limited to, solid-state memories and optical and magnetic media.

Embodiments of a dynamically configurable apparatus and methods for dynamically configuring the apparatus have been described. Although the present embodiments have been described, it will be evident that various modifications and changes may be made to these embodiments. Accordingly, the specification and drawings are to be regarded in an illustrative rather than a restrictive sense.

The Abstract of the Disclosure is provided to comply with 37 C.F.R. §1.72(b), requiring an abstract that allows the reader to quickly ascertain the nature of the technical disclosure. It is submitted with the understanding that it will not be used to interpret or limit the claims. In addition, in the foregoing Detailed Description, it may be seen that various features are grouped together in a single embodiment for the purpose of streamlining the disclosure. This method of disclosure is not to be interpreted as limiting the claims. Thus, the following claims are hereby incorporated into the Detailed Description, with each claim standing on its own as a separate embodiment.

What is claimed is:

1. A method comprising:
dynamically identifying a list of resources available to an apparatus;
in response to the identification,
communicating the list of resources to a server computer;
obtaining from the server computer a list of functionalities performable by the apparatus based on the list of resources;
receiving from a user a selection from the list of functionalities;
receiving from the server computer additional resources based on the selection; and
configuring the apparatus to perform selected functionalities by using the additional resources.

2. The method of claim 1, wherein dynamically identifying the list of resources comprises identifying the list of resources initially and also upon detecting a change in the resources.

3. The method of claim 1, wherein obtaining from the server computer comprises requesting from the server computer the list of functionalities and in response to the requesting, receiving from the server computer the list of functionalities over a network.

4. The method of claim 1, further comprising communicating the selection to the server computer.

5. The method of claim 1, wherein the resources include at least one of software, hardware, an interface, a database and a resource associated with an external device coupled to the apparatus.

6. The method of claim 5, wherein a functionality related to the resources associated with the external device is automatically disabled after the external device is decoupled from the apparatus.

7. The method of claim 1, wherein the additional resources include at least one of software and a database, the database including at least one of libraries, configuration files, images and fonts.

8. The method of claim 1, further including receiving a desired functionality for the apparatus from the user and obtaining from the server computer a list of one or more external devices for coupling to the apparatus to enable the apparatus to perform the desired functionality.

9. An apparatus comprising:
an identification module to dynamically identify a list of resources available to the apparatus;
a network interface device to communicate to a server computer the list of resources;
the network interface device to receive from the server computer a list of functionalities performable by the apparatus based on the list of resources;
a user interface device to receive from a user a selection from the list of functionalities;
the network interface device to receive from the server computer additional resources based on the selection; and
a configuration module to configure the apparatus to perform selected functionalities by using the additional resources.

10. The apparatus of claim 9, wherein the identification module is to identify the list of resources initially and also upon detecting a change in the resources.

11. The apparatus of claim 9, wherein the network interface device is to communicate a request to the server computer for the list of functionalities.

12. The apparatus of claim 9, wherein the network interface device is to communicate the selection to the server computer.

13. The apparatus of claim 9, wherein the identification module is to identify resources including at least one of software, hardware, an interface, a database and a resource associated with an external device coupled to the apparatus.

14. The apparatus of claim 13, wherein the configuration module is to automatically disable a functionality related to the resource associated with the external device after the external device is decoupled from the apparatus.

15. The apparatus of claim 9, further including a database server to store executables, libraries and a current apparatus configuration in a database.

16. The apparatus of claim 15, wherein the network interface is to obtain from the server computer a list of one or more external devices for coupling to the apparatus to enable the apparatus to perform the desired functionality.

17. A method comprising:
at a server computer,
receiving from an apparatus, over a network, a list of identified resources available to the apparatus;
providing to the apparatus a list of functionalities performable by the apparatus based on the list of identified resources;
receiving from the apparatus a user selection from the list of functionalities; and
providing the apparatus with additional resources based on the user selection.

18. The method of claim 17, further including generating a database to store the list of identified recourses, the list of functionalities and a current configuration of the apparatus.

19. The method of claim 18, further including dynamically updating the database.

20. The method of claim 17, further including providing the apparatus with promotional materials to be presented to the user.
